(19) United States
(12) Patent Application Publication
(10) Pub. No.: US 2023/0409404 A1
(43) Pub. Date: Dec. 21, 2023

(54) LOAD DISTRIBUTION APPARATUS, LOAD DISTRIBUTION SYSTEM, AND LOAD DISTRIBUTION METHOD

(71) Applicant: Hitachi, Ltd., Tokyo (JP)

(72) Inventor: Seito MIYAZAKI, Tokyo (JP)

(21) Appl. No.: 18/115,845

(22) Filed: Mar. 1, 2023

(30) Foreign Application Priority Data
Jun. 20, 2022 (JP) 2022-099262

(51) Int. Cl. G06F 9/50

(52) U.S. Cl. CPC G06F 9/505; G06F 9/5044

(57) ABSTRACT

The present invention provides provide a load distribution apparatus, a load distribution system, and a load distribution method that can contribute from an economical point of view while ensuring user convenience, by reducing the cost associated with unused resources while suppressing the occurrence of deployment processing delays and adverse effects on service provision. The load distribution apparatus includes a schedule mechanism that deploys container to node of the container base, and a scale mechanism that acquires resource data from the container base. The scale mechanism acquires external data about container to be deployed on the container base, determines resource of the container base based on the resource data and the external data, deletes node of the container base if it is determined that the resource is excessive, and adds node of the container base if it is determined that shortage of the resource.

### BACKGROUND OF THE INVENTION

### 1. Field of the Invention

The present invention relates to a load distribution apparatus, a load distribution system, and a load distribution method.

### 2. Description of the Related Art

There is an environment where multiple containers are deployed and share limited hardware resources. In this environment, there is a needs that achievement both cost reduction and respond adjusted to service load by efficiently using hardware resources.

Here, JP-A-2021-530801 discloses a technique for efficiently allocating cluster resources. Therefore, JP-A-2021-530801 discloses a method for allocating and managing a cluster resource on a cloud platform, the method comprising the steps of: generating service group information, by means of a cloud platform system, when a cluster resource allocation request is input; adding/deleting a user of the service group; selecting a cluster to be allocated to the user of the service group and inputting allocation information; querying a cluster resource availability; registering resource allocation information in the service group and allocating a resource to complete cluster resource allocation, when the resource is available as a result of the querying of the cluster resource availability; checking whether a cluster resource can be added when the resource is insufficient as a result of the querying of the cluster resource availability; registering the further cluster resource when the cluster resource can be added; registering resource allocation information in the service group and allocating the resource to complete cluster resource allocation; and reselecting an available cluster when the cluster resource cannot be added.

In addition, JP-A-2013-175085 discloses a technique for accurately predicting the resource capacity required for an IT service from monitoring information of resources with different monitoring conditions. That is, JP-A-2013-175085 discloses a resource capacity prediction device that includes log reliability calculation means and resource usage rate transition estimation means. The log reliability calculation means acquires a first log regarding the resource monitoring status from the computer, and calculates the reliability of the log at a plurality of times based on the information on the monitoring status at a plurality of times of the computer included in the first log. The resource usage rate transition estimating means acquires a second log relating to resource usage and a third log relating to measurement of service level items of the computer, from the computer, and estimates computer resource usage rate, based on information on the resource usage rate of the computer at plurality of times included in the second log, information of the measured value of the service level item at plurality of times of the computer included in the third log, and the reliability of the log at plurality of times.

By using the techniques of JP-A-2021-530801 and JP-A-2013-175085, it is conceivable that resources in the container base on which containers are deployed can be managed.

However, although container scale can be done quickly, it takes time to process the node that becomes the resource base in the container base, for example, when adding a node while the state of the container base operating rate is high, it may be delayed the process of deploying the container, and it may be adversely affected the provision of services to users. On the other hand, if resources are allowed to have leeway in consideration of these circumstances, it is occurred waste of cost for resources that are not in operation.

Therefore, an object of the present invention is to provide a load distribution apparatus, a load distribution system, and a load distribution method that can contribute from an economical point of view while ensuring user convenience, by reducing the cost associated with unused resources while suppressing the occurrence of deployment processing delays and adverse effects on service provision.

### SUMMARY OF THE INVENTION

According to a first aspect of the invention, there is provided a load distribution apparatus including: a schedule mechanism and a scale mechanism. The schedule mechanism deploys container to node of container base. The scale mechanism acquires resource data from the container base. In addition, the scale mechanism acquires external data about container to be deployed on the container base. The scale mechanism determines resource of the container base based on the resource data and the external data, deletes node of the container base if it is determined that the resource is excessive, and adds node of the container base if it is determined that shortage of the resource.

According to a second aspect of the invention, there is provided a load distribution system including: a container base includes multiple nodes that store container, and a load distribution apparatus which is connected to the container base and deploys container to node of the container base. The load distribution apparatus includes a processor and a storage unit. The processor acquires resource data from the container base and stores the acquired resource data in the storage unit, and acquires external data about container to be deployed on the container base and stores the acquired external data in the storage unit. The processor determines resource of the container base based on the resource data and the external data stored in the storage unit, deletes node of the container base when determining that the resource is excessive, and adds node of the container base when determining that shortage of the resource.

According to a third aspect of the invention, there is provided a load distribution method. The load distribution method is a method that uses load distribution apparatus that includes a processor and a storage unit and deploys data to node of container base. The processor acquires resource data from the container base and stores the acquired resource data in the storage unit, acquires external data about container to be deployed on the container base and stores the acquired external data in the storage unit, determines resource of the container base based on the resource data and the external data stored in the storage unit, deletes node of the container base when determining that the resource is excessive, and adds node of the container base when determining that shortage of the resource.

### Advantageous Effect

According to the present invention, a load distribution apparatus, a load distribution system, and a load distribution method possible to contribute from an economic point of view while ensuring user convenience are provided, by reducing the cost associated with unused resources while suppressing the occurrence of deployment processing delays and adverse effects on service provision. Note that, problems, configurations, and effects other than those described above will be clarified by the following description of the mode for carrying out the invention.

### BRIEF DESCRIPTION OF THE DRAWINGS

FIG. 1 is a diagram showing an overview of an example of processing by the load distribution apparatus.

FIG. 2 is a diagram showing an overview of an example of applying a load distribution apparatus in combination with a CI/CD pipeline of a development environment.

FIG. 3 is a diagram showing an overview of an example of applying a load distribution apparatus in combination with a CI/CD pipeline of a development environment.

FIG. 4 is a diagram showing an example of the configuration of a load distribution apparatus.

FIG. 5 is a flowchart showing an example of processing of the schedule mechanism.

FIG. 6 is a flowchart showing an example of processing of the scale mechanism.

FIG. 7 is a diagram showing an example of data to be acquired from the CI/CD pipeline.

FIG. 8A is a flowchart showing an example of scale determination.

FIG. 8B is a continuation of FIG. 8A, and is a flowchart showing an example of scale determination.

FIG. 9 is a diagram showing an example of data to be acquired regarding node groups.

FIG. 10 is a diagram showing an example of the previous value and the current value, which is the data to be acquired regarding the node group.

FIG. 11 is a flowchart showing an example of processing when adding a node.

FIG. 12 is a flowchart showing an example of processing when deleting a node.

FIG. 13 is a diagram showing an example of calculation results of (A) and (ΔA).

FIG. 14 is a diagram showing an example of scale determination results.

FIG. 15 is a diagram showing an example of calculation results of surplus resource costs.

FIG. 16 is a diagram showing a hardware configuration example of the entire system.

### DESCRIPTION OF THE PREFERRED EMBODIMENTS

Hereinafter, embodiments of the present invention will be described with reference to the drawings. The embodiments are examples for explaining the present invention, and are appropriately omitted and simplified for clarity of explanation. The present invention can also be implemented in various other forms. Examples of various types of data are described using expressions such as “table”, “list”, and “queue”, but various types of data may be expressed in data structures other than these. For example, various data such as “XX table”, “XX list”, and “XX queue” may be referred to as “XX data”. When describing identification data, expressions such as “identification data”, “identifier”, “name”, “ID”, and “number” are used, but these can be replaced with each other.

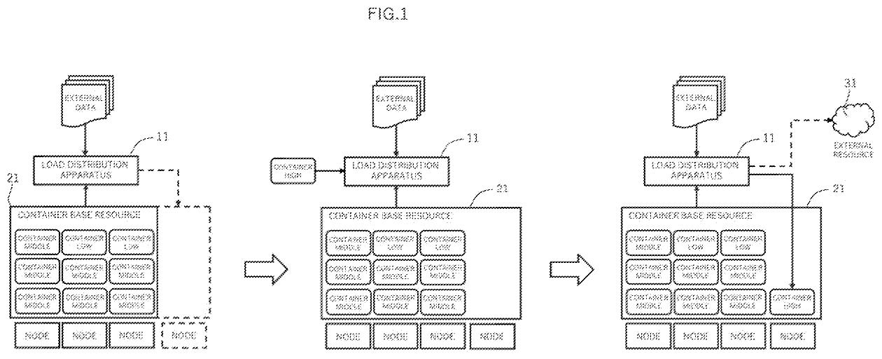

First, with reference to FIGS. 1 to 3, an outline of a processing example of the load distribution apparatus according to this embodiment will be described. The load distribution apparatus 11 can manage resources of the container base 21. That is, as shown in FIG. 1, for example, when the resource of the container base 21 is insufficient and a container cannot be deployed on the container base 21, the load distribution apparatus 11 performs control to add a node of the container base 21. Here, the load distribution apparatus 11 acquires external data in addition to data from the container base 21, and performs control to add a node based on the data. Note that, the external data is data about container to be deployed on the container base 21, and is data according to the use of the environment (for example, data about the status of CI jobs in a development environment). Then, when a node is newly added to the container base 21, the load distribution apparatus 11 deploys the container to the container base 21 (in this example, the added node). Note that, the external resource 31 may be used depending on the situation. Also, in FIG. 1 and the like, “high”, “middle”, and “low” express the priority of processing.

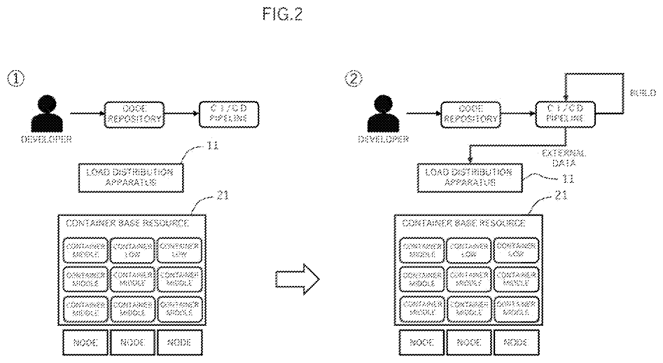

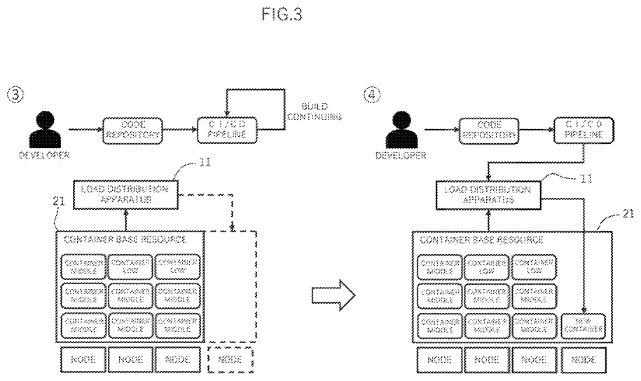

Next, with reference to FIGS. 2 to 3, an example of applying the load distribution apparatus 11 in combination with a CI/CD pipeline of development environment will be described. As shown in FIG. 2, when a developer pushes code and the CI/CD pipeline starts, a container image is generated (built) in the CI/CD pipeline. Here, the load distribution apparatus 11 detects the start of the pipeline and acquires external data about the container. And when generating the container to deploy (thus, while continuing the build in the build stage), the load distribution apparatus 11 performs control to add a node in the container base 21 according to data from the container base 21 and external data. After that, the load distribution apparatus 11 deploys the built container image to the container base 21, and a test (test stage) for verifying the code is started.

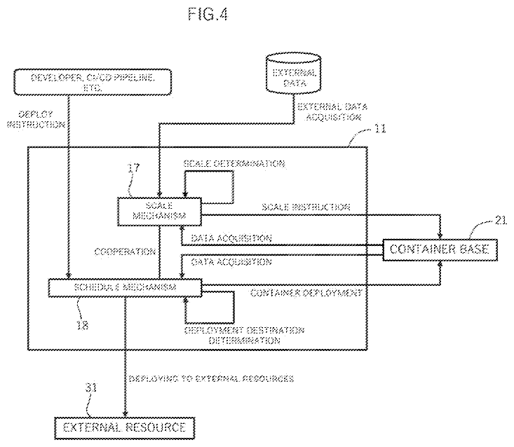

Next, a configuration example of the load distribution apparatus will be described with reference to FIG. 4. FIG. 4 is a diagram showing an example of the configuration of a load distribution apparatus. As shown in FIG. 4, the load distribution apparatus 11 includes a scale mechanism 17 and a schedule mechanism 18 as program modules, in the load distribution apparatus 11, the scale mechanism 17 and the schedule mechanism 18 cooperate to perform processing. The scale mechanism 17 performs scaling based on the resource usage status of the container base 21 and external data. That is, the scale mechanism 17 performs scale-out/in determination according to the resource of the container base 21. The schedule mechanism 18 determines deployment to the container base 21 or the external resource 31 for each container for which a deployment instruction has been issued, based on the described request.

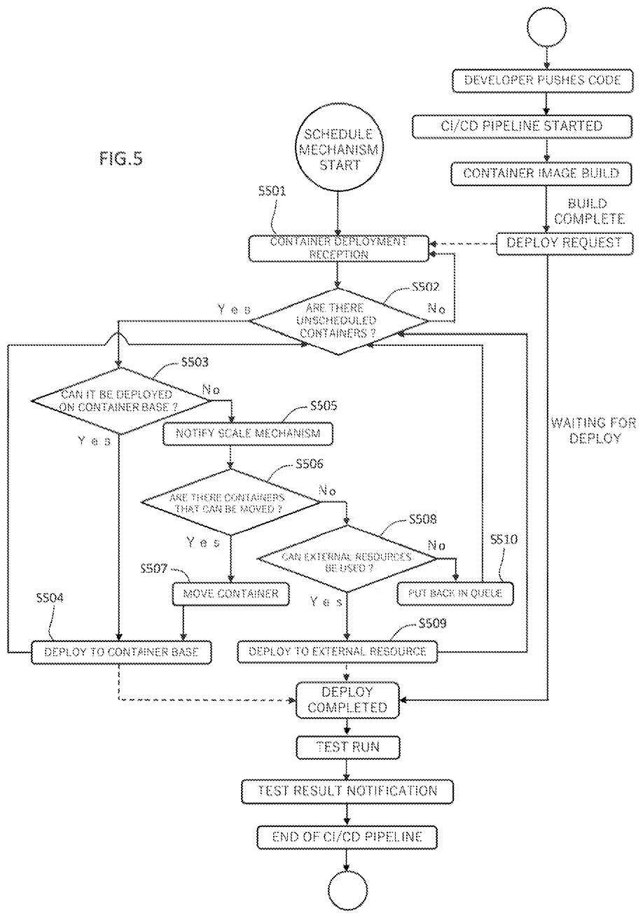

Next, an example of processing of the schedule mechanism will be described with reference to FIG. 5. FIG. 5 is a flowchart showing an example of processing of the schedule mechanism. In the example of FIG. 5, input/output of data from/to the outside is indicated by broken lines. In this example, the flow of a series of processing in the development environment will be described. That is, the developer pushes code, the CI/CD pipeline starts, and the container image build begins, as described above. After the build is completed, a deploy request (deploy instruction) is input to the load distribution apparatus. After the deployment is completed, tests are executed and the CI/CD pipeline ends.

The schedule mechanism 18 accepts a container deployment request (S501). Also, the schedule mechanism 18 determines whether there are unscheduled containers (that is, whether there are containers that have not yet been processed) (S502). Here, if there is an unscheduled container, the schedule mechanism 18 determines whether the resource of the container to be deployed exists in the container base 21 and whether this container can be deployed (S503). Then, if deployable, the schedule mechanism deploys this container (S504).

On the other hand, if it is determined that the deployment is not possible, the schedule mechanism 18 notifies the scale mechanism 17 to that effect (S505), and determines whether or not there is a container that can be moved in the container base 21 (S506). If it is determined that there is a container that can be moved, the schedule mechanism 18 moves this container (S507), and deploys an unscheduled container (S504). If it is determined that there is no container that can be moved, the schedule mechanism 18 determines whether the external resource 31 can be used based on the data of unscheduled containers (S508). The schedule mechanism 18 deploys the unscheduled container to the external resource 31 when determining that the external resource 31 can be used (S509). On the other hand, if it determines that the external resource cannot be used, the schedule mechanism 18 returns the unscheduled container to the queue (S510).

Note that, the deploy request includes descriptions of resources (CPU, memory, persistent storage) required by the container, etc. Depending on this request, there may be containers that can only be deployed on specific nodes (for example, when using AWS EBS that has already been created as persistent storage, it cannot be deployed outside the AZ where EBS is located), but the schedule mechanism 18 performs determination based on such data as well.

In addition, the schedule mechanism 18 determines as appropriate whether the external resource 31 can be used. For example, if a container to be deployed (thus, an unscheduled container) does not communicate with other containers (e.g. for unit testing), the schedule mechanism 18 determines that the external resource 31 can be used because it does not necessarily have to be deployed in the cluster. On the other hand, if the container to be deployed has dependency on other container, the schedule mechanism 18 determines that the external resource 31 cannot be used because it will not work if deployed to a different location.

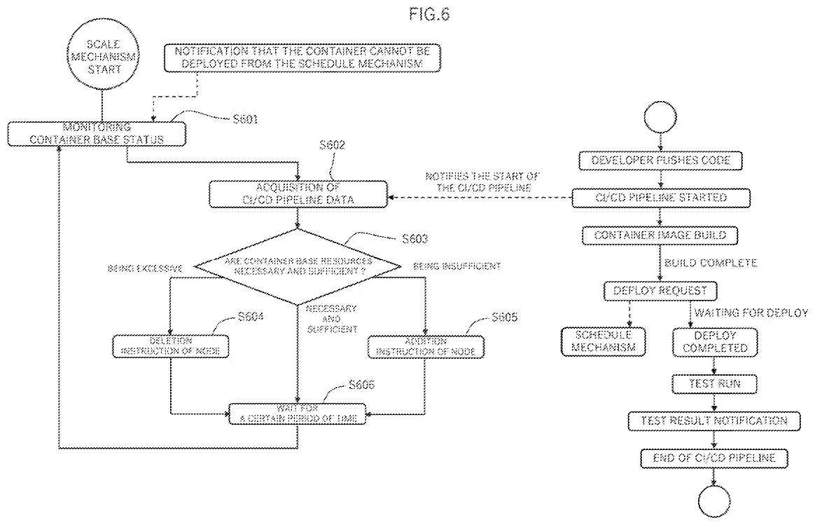

Next, an example of processing of the scale mechanism will be described with reference to FIG. 6. FIG. 6 is a flowchart showing an example of processing of the scale mechanism. Note that, in the example of FIG. 6, input/output of data from/to the outside is indicated by broken lines. In this example, similarly in the case of the schedule mechanism, a series of processing in the development environment will be explained.

The scale mechanism 17 monitors the state of the container base 21 (S601). Also, the scale mechanism 17 acquires CI/CD pipeline data (S602). Then, the scale mechanism 17 determines whether or not the resource of the container base 21 is necessary and sufficient (S603). Here, when it is determined that the resources of the container base 21 are excessive, the scale mechanism 17 instructs deletion of node in the container base 21 (S604). On the other hand, if it is determined that the resource of the container base 21 is insufficient, the scale mechanism 17 instructs addition of node on the container base 21 (S605). When the scale mechanism 17 determines that the resources of the container base 21 are necessary and sufficient, it does not scale (that is, add or delete node). Then, the scale mechanism 17 waits for a certain period of time (S606), and repeats the process.

The scale mechanism 17 performs the above scale determination based on the notice from the schedule mechanism 18 that the container cannot be deployed and/or the notice that the CI/CD pipeline is started. Note that, the details of scale determination will be described later.

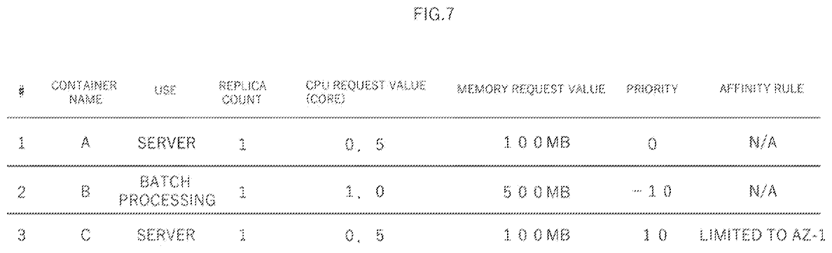

Next, an example of CI/CD pipeline data acquired by the scale mechanism 17 as external data will be described with reference to FIG. 7. FIG. 7 is a diagram showing an example of data acquired from the CI/CD pipeline. From the CI/CD pipeline, the required resource of the container to be deployed, type, use (batch processing or server), priority, and dependency are acquired. Note that, these data are mostly described in the deployment request, and are assumed to be managed in the repository in the same way as the application source code.

As shown in FIG. 7, the CI/CD pipeline data includes, for example, a container name (container identification data), a use (container use), a replica count, a CPU request value (container requested resource), a memory request value (container requested resource), a priority (processing priority), and an affinity rule. And in this example, this data is grouped each container. The replica count indicates the number of copies of data that want to store in the cluster. The CPU request value is the request value of the CPU (the core of the CPU in this example), and the memory request value is the request value of the memory. Priority indicates the priority of processing the container. In this example, the load distribution apparatus 11 preferentially processes container having a high positive priority. Therefore, the load balancer 11 preferentially processes the container C, then processes the container A, and then processes the container B. Affinity rules indicates constraints. In this example, there is a description about AZ (availability zone), “Limited to AZ-1” of container C defines the conditions under which container C is deployed to nodes in AZ-1. By setting affinity rules in this way, it is possible to process container having dependency condition.

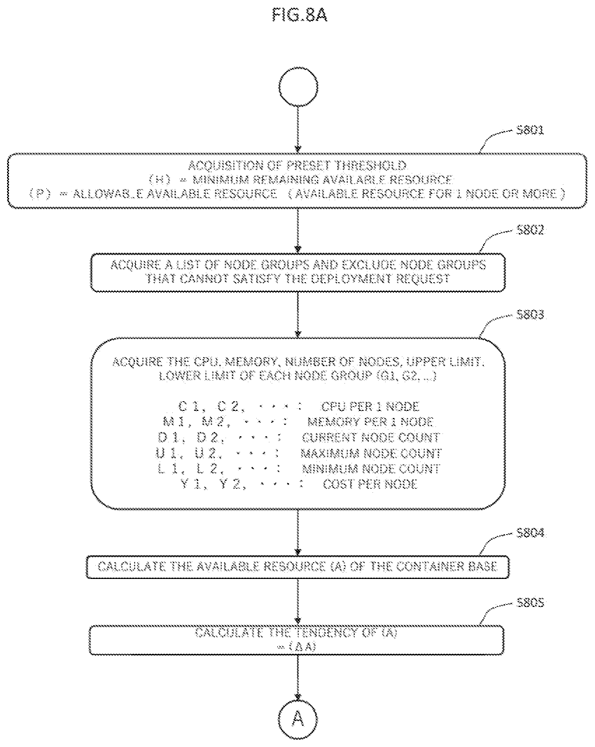

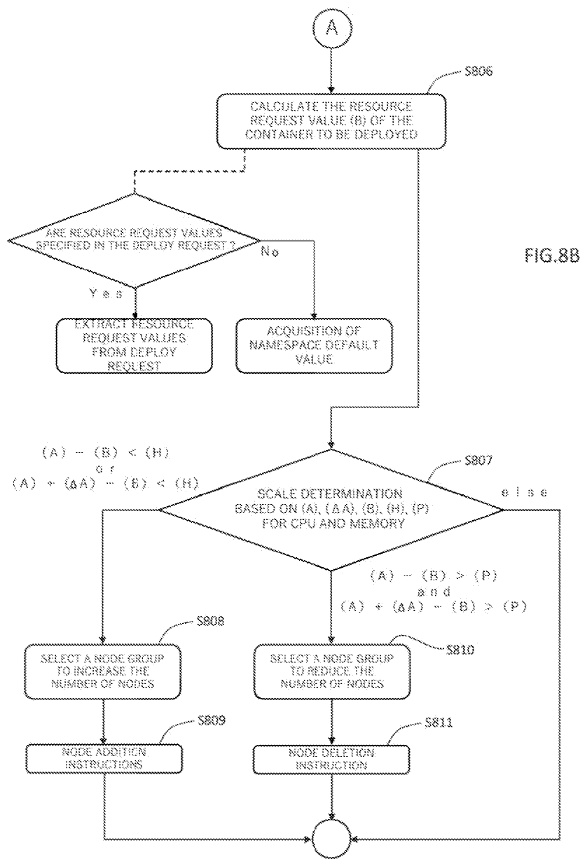

Next, an example of scale determination will be described with reference to FIGS. 8A and 8B. FIGS. 8A and 8B are flowcharts showing an example of scale determination. Here, scale determination when the data shown in FIG. 7 is acquired will be described. Therefore, an example of scale determination based on container C, which has a high priority, will be described.

First, the scale mechanism 17 acquires a preset threshold value (S801). That is, the scale mechanism 17 acquires the threshold value H and the threshold value P. Here, the threshold H defines the minimum remaining available resource. The threshold value P defines an allowable available resource, and is set so that there are resources for one or more nodes. In this specification, the threshold value H is sometimes indicated by (H), and the threshold value P by (P).

Next, the scale mechanism 17 acquires a list of node groups from the container base 21 and excludes node groups that cannot satisfy the deployment request (S802). The scale mechanism 17 excludes node groups that cannot satisfy the deployment request, for example, based on affinity rules. In scale determination based on container C, since there is a condition of “limited to AZ-1”, the scale mechanism 17 excludes node groups different from AZ-1.

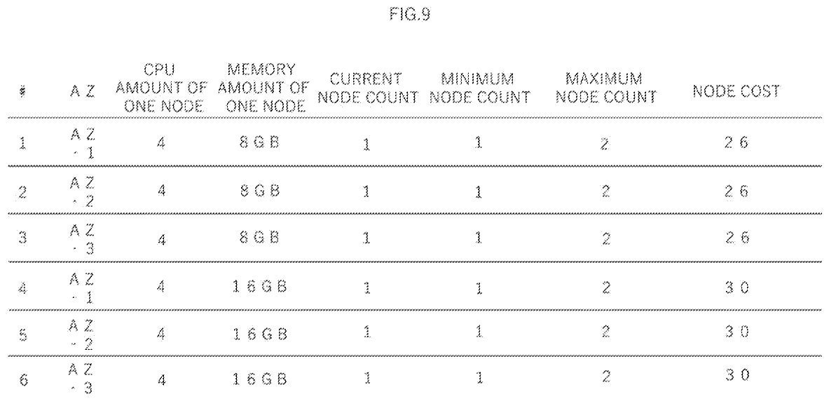

Here, an example of data acquired from the container base will be described with reference to FIG. 9. FIG. 9 is an example of data acquired regarding node groups.

In the example of FIG. 9, data is stored for each node group (#1 to #6). This data includes the availability zone of the node group, the CPU amount of one node in the node group, the memory amount of one node in the node group, the current node count, the minimum node count, the maximum node count, and the node cost.

Therefore, when the scale mechanism 17 performs scale determination based on the container C using the data shown in FIG. 9, the scale mechanism 17 excludes the node groups (#2, 3, 5, 6) related to “AZ-2” and “AZ-3” by the affinity rule, and proceeds with the process.

Next, the scale mechanism 17 acquires the CPU amount of one node, the memory amount of one node, the current node count, the upper limit (the maximum node count), and the lower limit (the minimum node count) (S803). Note that, in this example, the scale mechanism obtains data of the node group (#1, 4) in the scale determination based on the container C.

In the description of this specification, G1, G2, . . . may indicate each node group. Also, C1, C2, . . . may indicate the amount of CPU per node for each node group, M1, M2 . . . may indicate the amount of memory per node for each node group, D1, D2 . . . may indicate the current node count for each node group, U1, U2 . . . may indicate the maximum node count for each node group, L1, L2 . . . may indicate the minimum node count for each node group, and Y1, Y2, . . . may indicate the node cost per node for each node group.

Next, the scale mechanism 17 calculates the available resource (A) of the container base 21 (S804). Here, the scale mechanism 17, for the CPU and memory, calculates the difference between the resource of the node and the total that request value of the container or the average of the actual usage amount most recent, whichever is larger value, and calculates the sum of the differences for each node as (A). That is, the scale mechanism 17 calculates node resource—MAX (total container request value, average of actual usage amount most recent) for the CPU/memory of each node, and calculates the total as (A). Note that, in this example, the scale mechanism 17 performs calculation for node group #1 and node group #4.

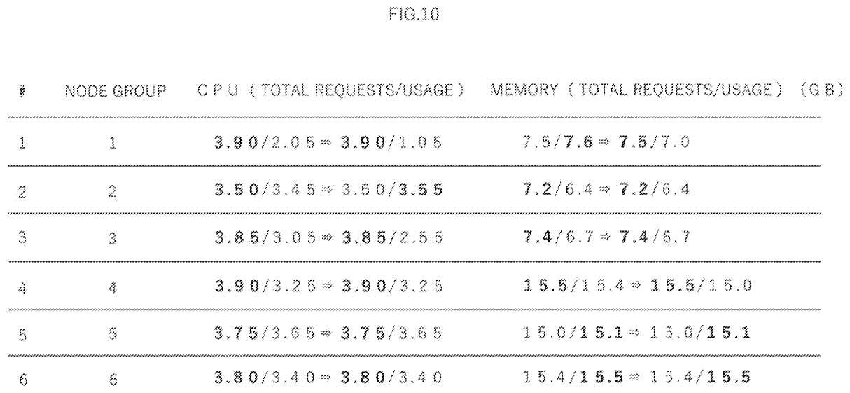

An example of the calculation of (A) will be described with reference to FIG. 10. FIG. 10 is a diagram showing an example of previous values and current values, which are data to be acquired regarding nodes. In the example of FIG. 10, the total request (that is, the total request value of the container) and the usage (average of the actual usage) for the CPU and memory resources of one node are stored for each node group.

In the case of node group #1, the total requests of the CPU of the previous value and the current value are 3.90, the CPU usage amount of the previous value is 2.05, and the CPU usage amount of the current value is 1.05. Also, the total requests of the memory of the previous value and the current value are 7.5, the memory usage amount of the previous value is 7.6, and the memory usage amount of the current value is 7.0.

Therefore, the scale mechanism 17 uses the CPU amount to 3.90 and the memory amount to 7.6, and calculates the CPU and memory available resources of the node in the previous node group #1. Also, the scale mechanism 17 uses the CPU amount to 3.90 and the memory amount to 7.5, and calculates the CPU and memory available resources of the node in the current node group #1.

In the case of node group #4, the total requests of the CPU of the previous value and the current value are 3.90, and the CPU usage amount for the previous value and the current value are 3.25. Also, the total requests of the memory of the previous value and the current value are 15.5, the memory usage amount of the previous value is 15.4, and the memory usage amount of the current value is 15.0.

Therefore, the scale mechanism 17 uses the CPU amount to 3.90 and the memory amount to 15.5, and calculates the CPU and memory available resources of the node in the previous node group #4. Also, the scale mechanism 17 uses the CPU amount to 3.90 and the memory amount to 15.5, and calculates the CPU and memory available resources of the node in the current node group #4.

Next, the scale mechanism 17 calculates (ΔA), which is the tendency of (A) (S805). The scale mechanism 17 calculates (ΔA) by subtracting the previous value of (A) from the current value of (A).

Next, the scale mechanism 17 calculates the resource request value of the container to be deployed (S806). In this specification, this resource request value is sometimes indicated by (B). The scale mechanism 17 checks whether resource request values are specified in the deployment request in the external data about the container to be deployed. Then, the scale mechanism 17 extracts the resource request value when the resource request value is specified in the deploy request, and acquires the default value of the namespace when the resource request value is not specified in the deploy request.

Then, the scale mechanism 17 performs scale determination for the CPU and memory based on (A), (ΔA), (B), (H), and (P) (S807). When the scale mechanism 17 determines that there is a relationship of (A)−(B)<(H) or (A)+(ΔA)−(B)<(H), the scale mechanism 17 selects a node group whose number of nodes is to be increased (S808), and instructs node addition (S809). Note that, details of S808 and S809 will be described later. When the scale mechanism 17 determines that there is a relationship of (A)−(B)>(P) and (A)+(ΔA)−(B)>(P), the scale mechanism. 17 selects a node group whose number of nodes is to be reduced (S810), and instructs node deletion (S811). Note that, details of S810 and S811 will be described later. Otherwise, the scale mechanism 17 does not scale (add or delete node).

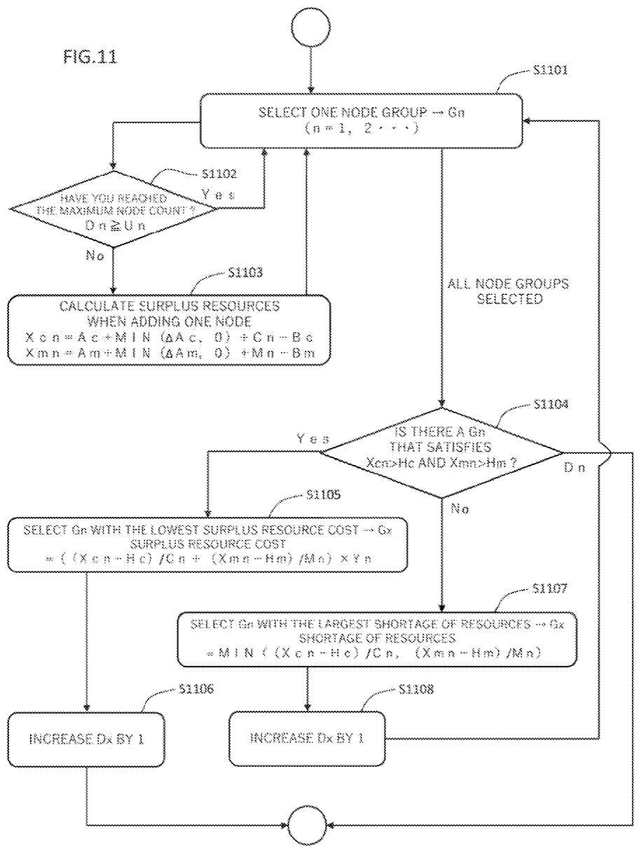

Details of the processing of S808 and S809 will be described with reference to FIG. 11. FIG. 11 is a flowchart showing an example of processing when adding a node.

The scale mechanism 17 selects one of the node groups (S1101), and determines whether the maximum node count has been reached for this node group (S1102). In FIG. 11, Dn indicates the current number of nodes in a certain node group, Un indicates the maximum node count in this node group. Then, when determining that the maximum node count has not been reached, the scale mechanism 17 calculates surplus resources when adding one node (S1103). The scale mechanism 17 performs such processing for all node groups.

Calculation of surplus resources when adding one node in S1103 will be described. The scale mechanism 17 calculates for each CPU and memory.

The scale mechanism 17, based on the formula Xcn=Ac+MIN(ΔAc,0)+Cn−Bc, calculates the surplus resources of the CPU. Here, in the formula, Xcn indicates the surplus resource of the CPU when adding one node in the target node group. Ac indicates available resource for the CPU. MIN(ΔAc,0) indicates using the smaller value of ΔAc or 0, and ΔAc indicates the tendency of Ac. ΔAc is calculated by subtracting the previous value of Ac from the current value of Ac. Cn indicates the CPU amount of one node in the target node group. Bc indicates a CPU request value based on external data about the container to be deployed.

The scale mechanism 17, based on the formula Xmn=Am+MIN(ΔAm, 0)+Mn−Bm, calculates the surplus resource of the memory. Here, in the formula, Xmn indicates the surplus resource of the memory when adding one node to the target node group. Am indicates available resources for memory. MIN (ΔAm,0) indicates using the smaller value of ΔAm or 0, and ΔAm indicates the tendency of Am. ΔAm is calculated by subtracting the previous value of Am from the current value of Am. Mn indicates the memory capacity of one node in the target node group. Bm indicates a memory request value based on external data about the container to be deployed.

After selecting all node groups, the scale mechanism 17 determines whether there is a node group (Gn) that satisfies Xcn>Hc and Xmn>Hm (S1104). Here, Hc indicates the value of (H) relating to the CPU, and Hm indicates the value of (H) relating to the memory. When determining that there is a node group that satisfies the above conditions, the scale mechanism 17 selects a node group with the lowest surplus resource cost (S1105). When determining that there is not a node group that satisfies the above conditions, the scale mechanism 17 selects a node group with the largest shortage resources (S1107).

S1105 will be described in detail. The scale mechanism 17 selects the node group (Gx) that minimizes ((Xcn−Hc)/Cn+(Xmn−Hm)/Mn) XYn. Here, Yn indicates the node cost of a certain node group. Then, the scale mechanism 17 increases the number of nodes of the selected node group (Gx) by 1 (S1106). In step S1105, about the CPU and the memory respectively, calculates how many surplus resources after the node addition corresponds to the number of nodes to be added, and obtains the calculated value by multiplying the sum by the node cost. The smaller this value, the node to be added fit the shortfall, and the surplus cost can be further reduced. (For example, if there is a CPU shortage, a node with more CPU is added, and if there is a memory shortage, a node with more memory is added).

S1107 will be described in detail. The scale mechanism 17 selects the node group (Gx) with the maximum MIN ((Xcn−Hc)/Cn, (Xmn−Hm)/Mn). Then, the scale mechanism 17 increases the number of nodes in the selected node group (Gx) by 1 (S1108). S1107 occurs when resource shortage cannot be resolved by adding any one node. Therefore, both arguments of the MIN function are always negative (thus, resource deficient). Here, when adding a node capable of resolving the resource shortage, the closer of the negative value is to 0, the resource shortage is resolved. Therefore, bypassing the MIN function, the value of the CPU or the memory, whichever is more deficient, is adopted, and a node is added to bring the value closer to 0.

After the node is added in S1108, the process returns to S1101, and the scale mechanism 17 shifts to the process of adding another node. Note that, if all node groups have reached the maximum node count, the scale mechanism 17 determines in S1104 to end processing.

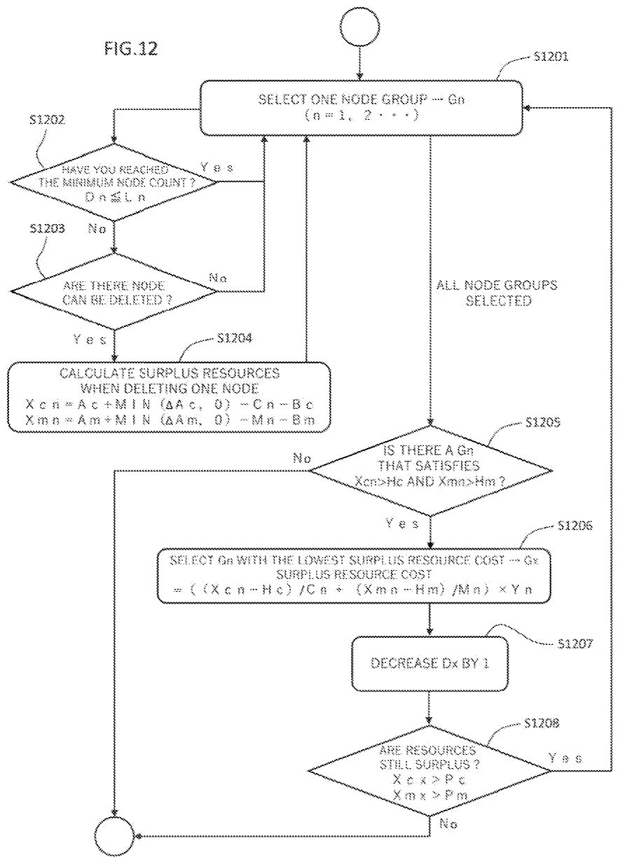

Details of the processing of S810 to S811 will be described with reference to FIG. 12. FIG. 12 is a showing flowchart an example of processing when deleting a node.

The scale mechanism 17 selects one of the node groups (S1201), and determines whether the minimum node count has been reached for this node group (S1202). In FIG. 12, Dn indicates the current number of nodes in a certain node group, and Ln indicates the minimum node count in this node group. Then, when the scale mechanism 17 determines that the number of nodes equal to or greater than the minimum number of nodes exists in the selected node group, it determines whether there is a node that can be deleted (S1203).

S1203 will be described in detail. When a node is deleted, evacuation of the container running on that node occurs. Basically, it is ideal that each container can be moved at any time, but there are some containers, such as batch processing container, where interruption of processing has a great effect. It is determined that such a container is not running=be able to delete. Note that, as for the method of specifying a container that cannot be moved, there are a method of automatic determination (for example, setting the container as a system management container) and a method of manual determination (for example, giving a label).

Then, if the scale mechanism 17 determines that there is a node that can be deleted, it calculates the surplus resource when deleting one node (S1204). The scale mechanism 17 performs such processing for all node groups.

Calculation of surplus resources when deleting one node in S1204 will be described. The scale mechanism 17 calculates for each CPU and memory.

The scale mechanism 17, based on the formula Xcn=Ac+MIN(ΔAc, 0)−Cn−Bc, calculates the surplus resources of the CPU. Here, in the formula, Xcn indicates the surplus resource of the CPU when deleting one node in the target node group. Ac indicates available resource for the CPU. MIN(ΔAc,0) indicates using the smaller value of ΔAc or 0, and ΔAc indicates the tendency of Ac. ΔAc is calculated by subtracting the previous value of Ac from the current value of Ac. Cn indicates the CPU amount of one node in the target node group. Bc indicates a CPU request value based on external data about the container to be deployed.

The scale mechanism 17, based on the formula Xmn=Am+MIN(ΔAm, 0)−Mn−Bm, calculates the surplus resource of memory. Here, in the formula, Xmn indicates the surplus resource of memory when deleting one node in the target node group. Am indicates available resource for memory. MIN(ΔAm, 0) indicates using the smaller value of ΔAm or 0, and ΔAm indicates the tendency of Am. ΔAm is calculated by subtracting the previous value of Am from the current value of Am. Mn indicates the memory amount of one node in the target node group. Bm indicates a memory request value based on external data about the container to be deployed.

After selecting all node groups, the scale mechanism 17 determines whether there is a node group (Gn) that satisfies Xcn>Hc and Xmn>Hm (S1205). Here, Hc indicates the value of (H) relating to the CPU, and Hm indicates the value of (H) relating to the memory. When determining that there is a node group that satisfies the above conditions, the scale mechanism 17 selects a node group with the lowest surplus resource cost (S1206).

S1206 will be described in detail. The scale mechanism 17 selects the node group (Gx) that minimizes ((Xcn−Hc)/Cn+(Xmn−Hm)/Mn)×Yn. Here, Yn indicates the node cost of a certain node group. Then, the scale mechanism 17 decrements the number of nodes in the selected node group (Gx) by 1 (S1207). In step S1206, about the CPU and the memory respectively, calculates how many surplus resources after the node deletion corresponds to the number of nodes to be deleted, and obtains the calculated value by multiplying the sum by the node cost. The smaller this value, the node to be deleted fit the surplus, and the surplus cost can be further reduced. (For example, if there is a CPU excessive, a node with more CPU is removed, and if there is a memory excessive, a node with more memory is removed).

After reducing the number of nodes in S1207, the scale mechanism 17 determines whether there are still surplus resources (S1208). If it is determined that the resources are surplus, the scale mechanism 17 returns to S1201 and proceeds to the process of further decreasing another node. Note that, in S1208, it is determined whether Xcx>Pc and Xmx>Pm are satisfied. Here, Xcx indicates the surplus resource of the CPU when deleting one node, for the node group processed in S1207. Xmx indicates the surplus resource of the memory when deleting one node, for the node group processed in S1207. Pc indicates (P) for the CPU, and Pm indicates (P) for the memory.

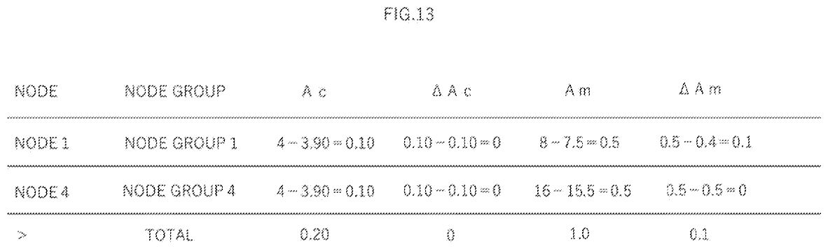

Next, an operation example of the scale mechanism will be described with reference to FIG. 13 to FIG. 15. In this example, a case will be described in which the data shown in FIG. 7 is obtained as the external data, and the data shown in FIGS. 9 and 10 is obtained as the container base data.

First, the scale mechanism 17 executes processing of container C, which has the highest priority. Here, the affinity rule for container C is referenced, and processing that satisfies the affinity rule is performed.

A scale mechanism 17 obtains a threshold value. Here, it is assumed that Hc=0, Hm=0, Pc=4, and Pm=8 (GB).

The scale mechanism 17 acquires data on the list of node groups (here, data shown in FIGS. 9 and 10) from the container base 21. The scale mechanism 17 continues processing while leaving only node group #1 and node group #4 according to the affinity rule.

The scale mechanism 17 calculates (A) and (ΔA). That is, the CPU and memory values are calculated. FIG. 13 shows the calculation result.

The scale mechanism 17 calculates (B) based on external data. Here, Bc=0.5 and Bm=0.1 are calculated.

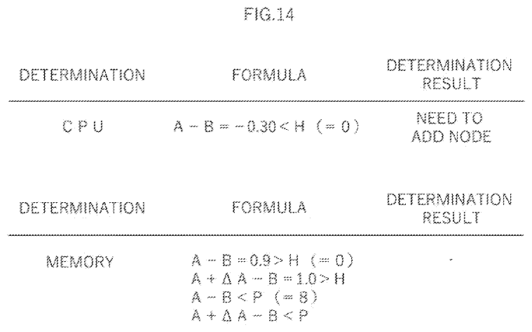

The scale mechanism 17 performs scale determination. FIG. 14 shows the determination result.

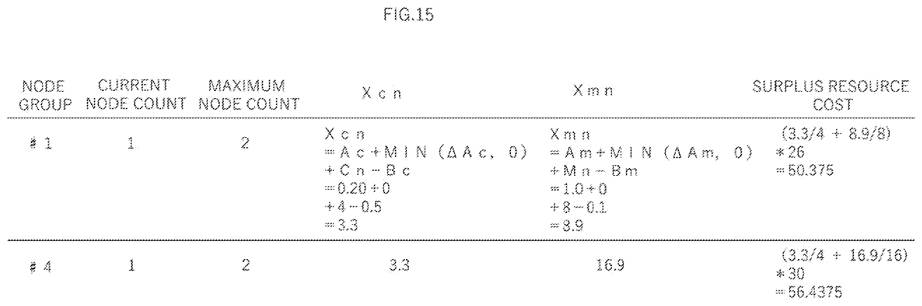

The scale mechanism 17 selects a node group to be scaled and performs scaling. FIG. 15 shows the calculation result of the surplus resource cost. In this example, since node group #1 has a lower surplus cost resource value, the number of nodes in node group #1 is added by 1 (1⇒2).

The scale mechanism 17 performs scale determination for the remaining containers A and B in the same procedure.

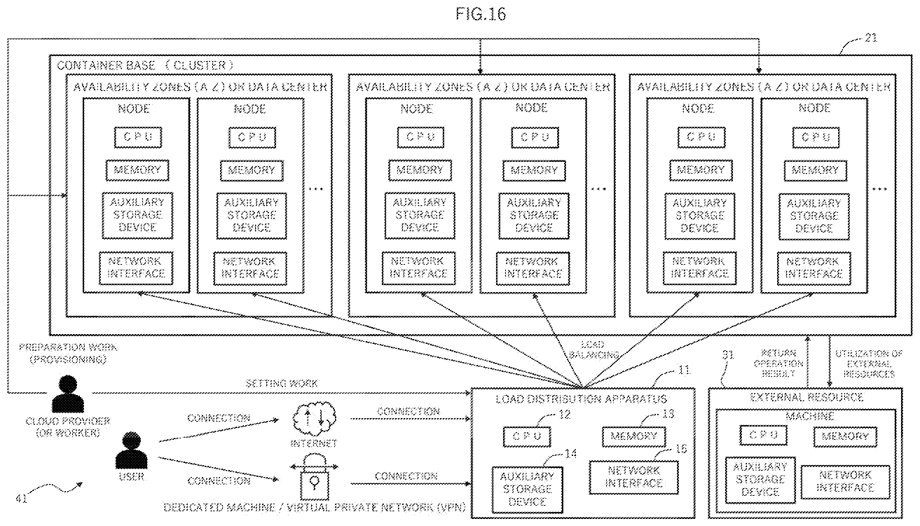

Next, an example of hardware configuration will be described with reference to FIG. 16. FIG. 16 is a diagram showing an example hardware configuration of the entire system.

As shown in FIG. 16, the system (load distribution system 41) includes a load distribution apparatus 11, a container base 21 (cluster), and an external resource 31. A user (for example, a developer) can connect a computer (client) to the load distribution apparatus 11 and use the load distribution apparatus 11. A user can connect, for example, to the Internet, a dedicated line, or a virtual private network (VPN). The cloud provider (or worker) performs setting work for the load distribution apparatus 11 and preparation work (provisioning) for the container base 21.

The load distribution apparatus 11 is configured as a computer including a CPU 12 (processor), a memory 13 (RAM in this example), an auxiliary storage device 14 (constituting a storage unit, SSD in this example), and a network interface 15, and is an apparatus that performs data load balancing and distributes data to nodes. The load distribution apparatus 11 executes the processing described above. Here, the auxiliary storage device 14 stores data such as acquired resource data and external data. Also, auxiliary storage device 14 stores scale mechanism 17 and schedule mechanism 18. And, the CPU 12 reads the data to the memory 13 and executes predetermined processing.

The container base 21 has a plurality of availability zones (or data centers), and nodes for deploying containers are appropriately arranged in each availability zone. In this example, the node is configured as a computer including a CPU, memory (RAM in this example), auxiliary storage device (SSD in this example), and network interface.

Also, the system includes an external resource 31, and the external resource 31 is configured including a computer (machine) comprising a CPU, a memory (RAM in this example), an auxiliary storage device (SSD in this example), and a network interface. The external resource 31 is used, for example, to evacuate containers as necessary when deploying containers.

Although the embodiments of the present invention have been described, the present invention is not limited to the embodiments and various design changes can be performed without departing from the spirit of the invention described in claims. For example, the embodiments are described in detail to facilitate the description of the present invention and the present invention is not limited to including all of the described configurations. In addition, a part of the configurations of the certain embodiment can be replaced by the configurations of other embodiments or the configurations of other embodiments can be added to the configurations of the certain embodiment. In addition, for a part of the configurations of the individual embodiments, addition/removal/replacement of other configurations can be performed.

Predetermined processing may be executed, and may be changed as appropriate. For example, although an example in which the CPU 12 is a processor has been described, other types of semiconductor devices may be used, and similar data processing may be performed. Although an SSD has been described as the auxiliary storage device 14, other types of devices (for example, HDD) may be used. Other hardware configurations may be modified as appropriate as long as they can execute predetermined processing.

Apart from the above development environment, the load distribution apparatus 11 determines the number of containers required based on the supply and demand forecast of resources in the production environment, and may determine the scale of the base, based on the resources of the container base 21. For example, demand is expected to increase at the end of the month and busy periods. Here, the load distribution apparatus 11, for example, may acquire (calculate) demand and supply forecasts based on data that automatically records changes in resources. In addition, the supply and demand forecast, for example, may be acquired from the outside and pre-registered in the load distribution apparatus 11. The load distribution apparatus 11 performs scale determination at the time needed, and prepares resources according to supply and demand forecasts in the production environment.

What is claimed is:

1. A load distribution apparatus, comprising:
a schedule mechanism that deploys container to node in container base, and
a scale mechanism that acquires resource data from the container base, wherein
the scale mechanism acquires external data about container to be deployed on the container base, determines resource of the container base based on the resource data and the external data, deletes node of the container base if it is determined that the resource is excessive, and adds node of the container base if it is determined that shortage of the resource.

2. The load distribution apparatus according to claim 1, wherein
as the external data, the scale mechanism acquires data about container to be deployed from CI/CD pipeline in development environment.

3. The load distribution apparatus according to claim 2, wherein
the data includes container identification data, container use, processing priority, container request resource, and affinity rule.

4. The load distribution apparatus according to claim 1, wherein
the scale mechanism performs scale determining of the container base, based on the supply and demand forecast of resource in the production environment and data of resource of the container base, and prepares resource according to the supply and demand forecast.

5. The load distribution apparatus according to claim 1, wherein
the schedule mechanism determines whether the container can be deployed on the container base based on a container deploy request,
when determining that the container can deploy, deploys the container on the container base,
when determining that the container cannot deploy, determines whether container can be deployed to external resource, and deploys the container to the external resource if it is determined that the container can be deployed to the external resource.

6. A load distribution system, comprising:
a container base includes multiple nodes that store container; and
a load distribution apparatus connected to the container base and deploys container to node of the container base, wherein
the load distribution apparatus includes a processor and a storage unit,
the processor acquires resource data from the container base and stores the acquired resource data in the storage unit, acquires external data about container to be deployed on the container base and stores the acquired external data in the storage unit, determines resource of the container base based on the resource data and the external data stored in the storage unit, deletes node of the container base when determining that the resource is excessive, and adds node of the container base when determining that shortage of the resource.

7. A load distribution method using a load distribution apparatus that includes a processor and a storage unit and deploys data to node of container base, wherein
the processor acquires resource data from the container base and stores the acquired resource data in the storage unit, acquires external data about container to be deployed on the container base and stores the acquired external data in the storage unit, determines resource of the container base based on the resource data and the external data stored in the storage unit, deletes node of the container base when determining that the resource is excessive, and adds node of the container base when determining that shortage of the resource.

8. A program causing a processor to execute the load distribution method according to claim 7.
